(19) United States
(12) Patent Application Publication
(10) Pub. No.: US 2021/0365932 A1
(43) Pub. Date: Nov. 25, 2021

(54) SYSTEM AND METHOD FOR TRUSTED OFFLINE PAYMENT TOKENS

(71) Applicant: MASTERCARD INTERNATIONAL INCORPORATED, Purchase, NY (US)

(72) Inventor: Sarang Chalikwar, Dublin (IE)

(73) Assignee: MASTERCARD INTERNATIONAL INCORPORATED, Purchase, NY (US)

(21) Appl. No.: 16/877,613

(22) Filed: May 19, 2020

(51) Int. Cl. G06Q 20/36; G06Q 20/40

(52) U.S. Cl. CPC G06Q 20/3678; G06Q 20/405; G06Q 20/3674

(57) ABSTRACT

Systems, apparatuses and methods may provide for technology for establishing and managing trusted payment tokens. The technology may include a database of trusted payment tokens and identifiers. The technology may receive a request for a trusted payment token, generate a trusted payment token based on parameters received, and return a trusted payment token identifier. The technology may further receive a trusted payment token identifier, verify the token based on parameters received, and return a token approval notice, authorizing a cash payment or deposit according to the token amount.

### FIELD OF THE DISCLOSURE

The present disclosure relates generally to payment transactions, and, more particularly, to systems and methods for establishing and managing trusted offline payment tokens.

### BACKGROUND

Despite recent advances in financial technology, if a user wants to obtain cash from an account, the user's options are limited. To withdraw cash from the account, the user must go to the bank where the user holds the account, or the user must go to an automated teller machine (ATM) that participates with the user's bank. The user cannot go to just any local bank or other financial institution and obtain the desired cash from the user's account. Similarly, if the user travels to a different location there may be no branch locations for the user's bank nearby. Thus, in some circumstances it may be impractical or inconvenient for the user to visit the user's bank, or a branch thereof, or a participating ATM.

Similarly, if the user wants to transfer cash to another person, the user's options are limited. The user may write a check, or initiate an electronic funds transfer (EFT) or a wire transfer, or share accounts with the other person. However, these methods may expose the user's account information to the other person, or the other person's account information to the user, or involve inconvenience and expense. The user may not want to provide or share account information with the other person, or may not want to go through the inconvenience and expense of initiating an electronic funds transfer or a wire transfer. Otherwise, the user must have the cash in hand to present directly to the other person. The user could also attempt to send the cash via mail or other delivery service, but that is a risky proposition.

In light of the foregoing, there exists a need for a solution for facilitating cash withdrawal or cash transfer transactions in a manner that is more convenient for the user, while maintaining the security of the user's account information, to overcome at least some of the deficiencies described herein.

### SUMMARY

Various embodiments of the present disclosure provide systems and methods for establishing and managing trusted offline payment tokens.

One or more embodiments of the present disclosure include a computing system for operating a trusted token repository. The system may include a processor and a database coupled to the processor, the database configured to store a plurality of trusted payment tokens, each trusted payment token comprising a payment token identifier, a payment amount, and one or more of a requestor institution identifier, a requestor user identifier, a recipient institution identifier, and a recipient user identifier. The system may further include a memory coupled to the processor, the memory storing instructions which, when executed by the processor, cause the computing system to receive from a recipient institution, via a network, a first payment token identifier and a first set of parameters, the first set of parameters including an identifier for a the recipient institution and a payment amount, retrieve a first trusted payment token from the database based on the received first payment token identifier, verify the first trusted payment token based on the received first set of parameters, and if the first trusted payment token is verified, send to the recipient institution, via the network, a token approval notification authorizing the recipient institution to pay the payment amount to a recipient user.

One or more embodiments of the present disclosure include at least one computer readable storage medium comprising a set of instructions which, when executed by a computing device, cause the computing device to receive from a recipient institution, via a network, a first payment token identifier and a first set of parameters, the first set of parameters including an identifier for a the recipient institution and a payment amount, retrieve a first trusted payment token from a database based on the received first payment token identifier, verify the first trusted payment token based on the received first set of parameters, and if the first trusted payment token is verified, send to the recipient institution, via the network, a token approval notification authorizing the recipient institution to pay the payment amount to a recipient user, where the database is configured to store a plurality of trusted payment tokens, each trusted payment token comprising a payment token identifier, a payment amount, and one or more of a requestor institution identifier, a requestor user identifier, a recipient institution identifier, and a recipient user identifier.

One or more embodiments of the present disclosure include a method of operating a trusted token repository. The method may include receiving from a recipient institution, via a network, a first payment token identifier and a first set of parameters, the first set of parameters including an identifier for the recipient institution and a payment amount. The method may further include retrieving a first trusted payment token from a database based on the received first payment token identifier, where the database is configured to store a plurality of trusted payment tokens, each trusted payment token comprising a payment token identifier, a payment amount, and one or more of a requestor institution identifier, a requestor user identifier, a recipient institution identifier, and a recipient user identifier. The method may further include verifying the first trusted payment token based on the received first set of parameters. The method may further include if the first trusted payment token is verified, sending to the recipient institution, via the network, a token approval notification authorizing the recipient institution to pay the payment amount to a recipient user.

Further features of the disclosed technology are explained in greater detail with reference to the detailed description that follows, including specific example embodiments described below and illustrated in the accompanying drawings.

### BRIEF DESCRIPTION OF THE DRAWINGS

The accompanying drawings illustrate various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements, and in which:

FIG. 1 provides a diagram of a system for establishing and managing trusted offline payment tokens according to one or more embodiments;

FIGS. 2A-2C provide diagrams illustrating process flows and interactions for establishing and managing trusted offline payment tokens according to one or more embodiments;

FIGS. 3A-3B illustrate aspects of trusted offline payment tokens according to one or more embodiments;

FIGS. 4A-4C provide flowcharts illustrating processes for establishing and managing trusted offline payment tokens according to one or more embodiments; and

FIG. 5 is a block diagram of a computing device according to one or more embodiments.

Further areas of applicability of the present invention will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example” and so on, indicate that the embodiment (s) or example (s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The embodiments described should be recognized as capable of implementation separately, or in combination, with other embodiments from the description of the embodiments.

### Overview

Various embodiments of the present disclosure provide a method and a system for establishing and managing trusted offline payment tokens. A trusted token repository may generate and store trusted offline payment tokens. In some embodiments, a requestor user may request, through a requestor institution, generation of a trusted payment token in order to withdraw cash through a recipient institution. The requestor user may take the trusted payment token to the recipient institution, which will have the token verified by the trusted token repository. Once the token is verified, the trusted token repository may return a token approval notice, authorizing a cash payment or deposit according to the token amount. The recipient institution may dispense the cash to the requestor user (who may be deemed a recipient user in this scenario). In some embodiments, the recipient institution may deposit the cash amount in an account on behalf of the requestor (recipient) user.

In some embodiments, a requestor user may request, through a requestor institution, generation of a trusted payment token in order to transfer cash to a second user (who may be deemed a recipient user in this scenario). The requestor user may transfer the trusted payment token to the recipient user. The recipient user may take the token to the recipient institution, which will have the token verified by the trusted token repository. Once the token is verified, the trusted token repository may return a token approval notice, authorizing a cash payment or deposit according to the token amount. The recipient institution may dispense the cash to the recipient user. In some embodiments, the recipient institution may deposit the cash amount in an account on behalf of the recipient user.

Thus, the methods and the systems, in accordance with various embodiments of the present invention, facilitates cash withdrawal or cash transfer transactions in a manner that is more convenient for the user, while maintaining the security of the user's account information. To enhance security, the requestor user may be requested to provide identification and account information, as well as the identify of a recipient institution and of any recipient user, to the requestor institution, which may verify the identity of the requestor user. Similarly, to enhance security a recipient user may be requested to provide identification and account information to the recipient institution, which may verify the identity of the recipient user.

### Terms Description (in Addition to Plain and Dictionary Meaning

Server is a physical or cloud data processing system on which a server program runs. A server may be implemented in hardware or software, or a combination thereof. In some embodiments, a server includes a computer program that is executed on programmable computers, such as personal computers, laptops, or a network of computer systems. A server may be configured for data communication (such as, e.g., via a network or other connection) with other servers or other computing devices. A server may correspond to a requestor institution server, a recipient institution server, a trusted token repository server, or any other server used in conjunction with the systems disclosed herein.

Institution is a financial institution such as, for example, a bank, where accounts of several customers are established and maintained. An institution carries out financial transactions in accordance with various banking laws and regulations.

Accounts are maintained by users at one or more institutions. Accounts may be used to hold financial funds that may be used in financial transactions.

Trusted token repository may be a financial institution or other trusted entity or party that securely generates, stores and validates trusted offline payment tokens as described herein.

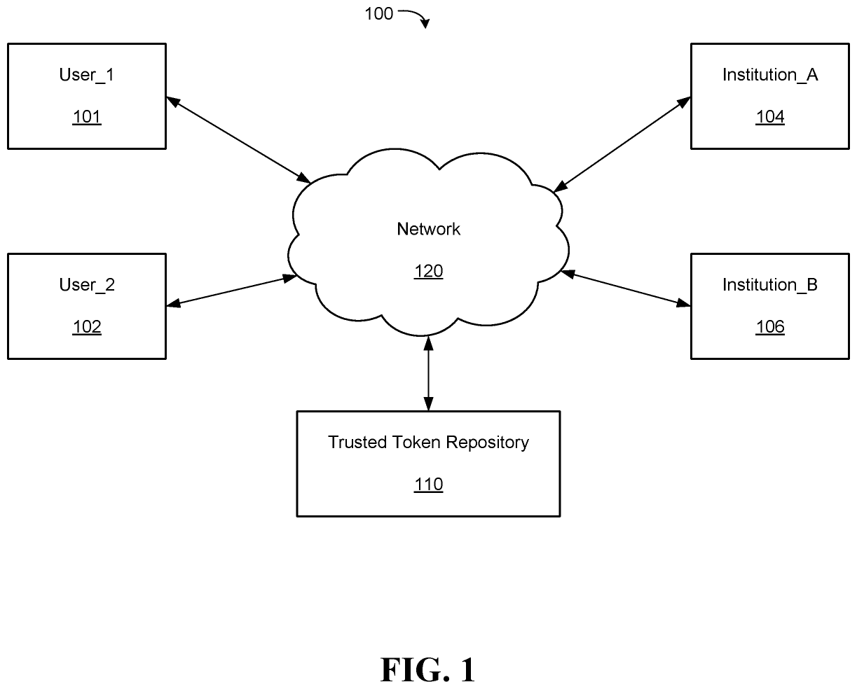

Various exemplary embodiments of the present invention have been further described in detail with reference to FIGS. 1 to 5.

FIG. 1 provides a diagram of a system 100 for establishing and managing trusted offline payment tokens according to one or more embodiments, with reference to components and features described herein including but not limited to the figures and associated description. As discussed further below, system 100 may include User_1 101, User_2 102, Institution_A 104, Institution_B 106, Trusted Token Repository 110, and network 120. Although FIG. 1 illustrates certain components, system 100 may include additional or multiple components connected in various ways. It is understood that not all embodiments may necessarily include every component shown in FIG. 1.

System 100 may include one or more users such as User_1 101 and User_2 102. A user such as User_1 101 and User_2 102 may connect to Network 120 via a client device, which may be a network-enabled computer. As referred to herein, a network-enabled computer may include, but is not limited to, a computer or communications device including, e.g., a server, a network appliance, a personal computer, a workstation, a handheld PC, a personal digital assistant, or other device. A client device also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some embodiments, a client device may be a point of sale (POS) device or kiosk. A client device may operate with various software programs or applications, such as, e.g., an Internet or web browser, and/or other communications applications. Additional features that may be included in a client device are further described below with reference to FIG. 5.

A user such as User_1 101 and User_2 102 may communicate with other entities, such as Institution_A 104 and/or Institution_B 106, through network 120 or another network. In some embodiments, as described below, a user such as User_1 101 and User_2 102 may communicate with Institution_A 104 and/or Institution_B 106 through other means, such as by in-person contact or other communication methods, without using network 120. A user may, in some transactions, be a requestor user as described herein, and may, in other transactions, be a recipient user as described herein. In some transactions, a user may be both a requestor user and a recipient user as described herein.

System 100 may include one or more institutions such as Institution_A 104 and Institution_B 106. Each institution, including Institution_A 104 and Institution_B 106, may include a server or other network-enabled computer for connecting to network 120 and communicating with other entities, such as User_1 101, User_2 102, and/or Trusted Token Repository 110, via network 120 or another network. An institution may communicate with some entities, such as a user, via one network, and may communicate with other entities, such as Trusted Token Repository, via another network. An institution may, in some transactions, be a requestor institution as described herein, and may, in other transactions, be a recipient institution as described herein. Additional features that may be included in an institution server or other network-enabled computer are further described below with reference to FIG. 5.

System 100 may include one or more trusted token repositories such as Trusted Token Repository 110. Trusted Token Repository 110 may include a server or other network-enabled computer for connecting to network 120 and communicating with other entities, such as Institution_A 104 and Institution_B 106, via network 120. Trusted Token Repository 110 may include one or more secure databases (not shown). Additional features that may be included in a trusted token repository server or other network-enabled computer are further described below with reference to FIG. 5.

Network 120 may include one or more individual networks, which may include public and/or private networks, and may include, for example, one or more of the Internet, a wide area network (WAN), a local area network (LAN), a cloud computing network, a wireless network, a telephone network, a cellular network, a satellite network, a fiber optic network, a WiFI network, a coaxial cable network, an infrared (IR) network, a radio frequency (RF) network, or any combination(s) thereof. Various entities in system 100 may connect to network 120 in accordance with various wired and/or wireless communication protocols, such as, for example, Transmission Control Protocol and Internet Protocol (TCP/IP), User Datagram Protocol (UDP), Long Term Evolution (LTE) communication protocols, any variant of IEEE 802.11 (such as, e.g., IEEE 802.11b, 802.11g, or 802.11n), Bluetooth, near field communication (NFC), Radio Frequency Identification (RFID), or any combination thereof. Parties may communicate electronically with each other as described herein via a network, such as network 120, via methods supported by any appropriate network technologies and protocols. Communications may be encrypted and decrypted using any appropriate cryptographic scheme.

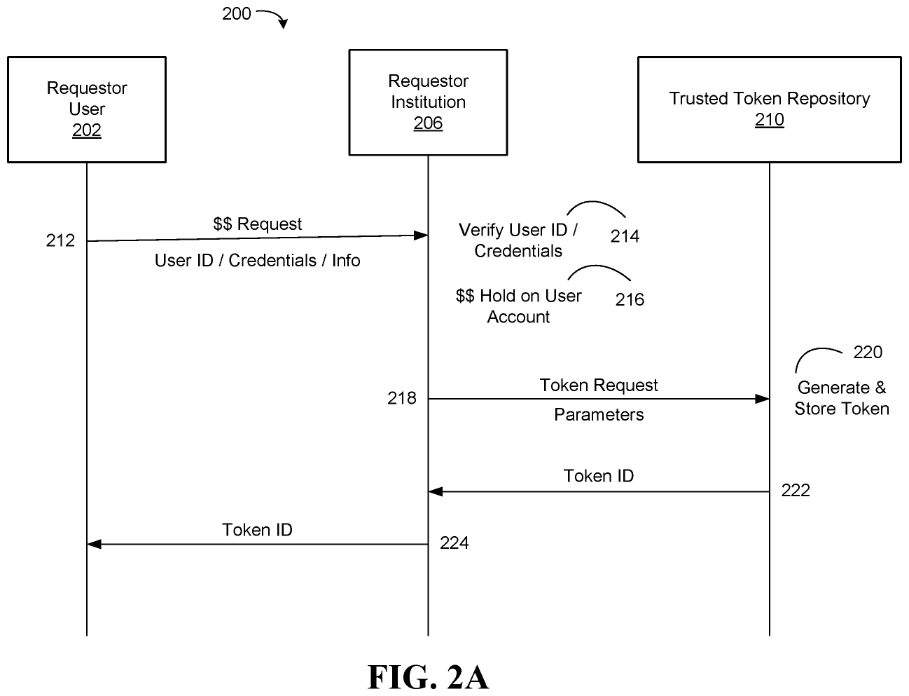

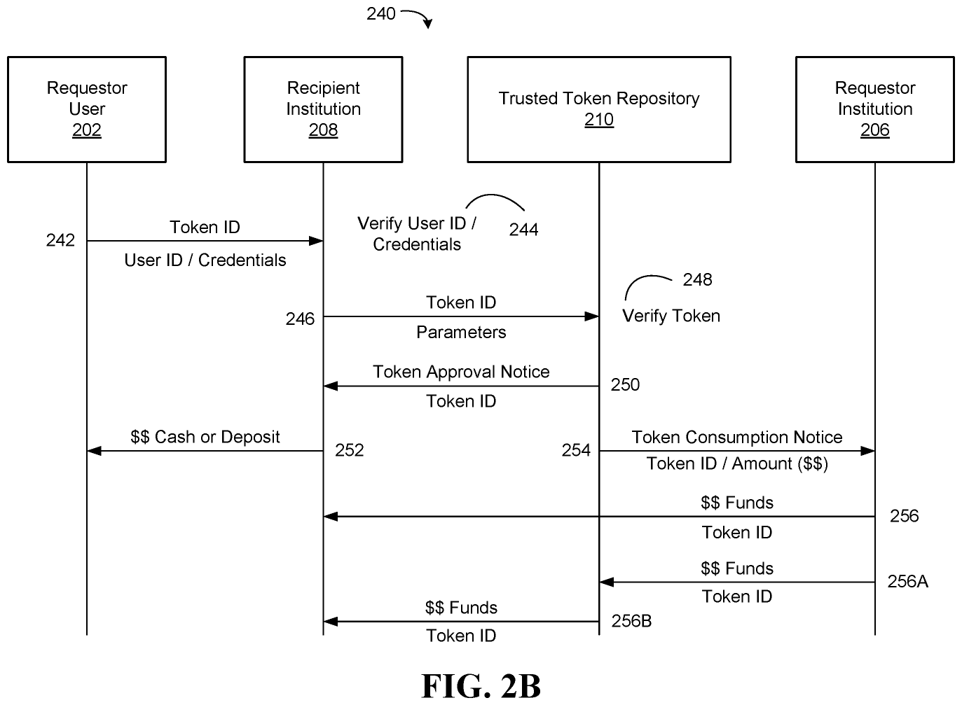

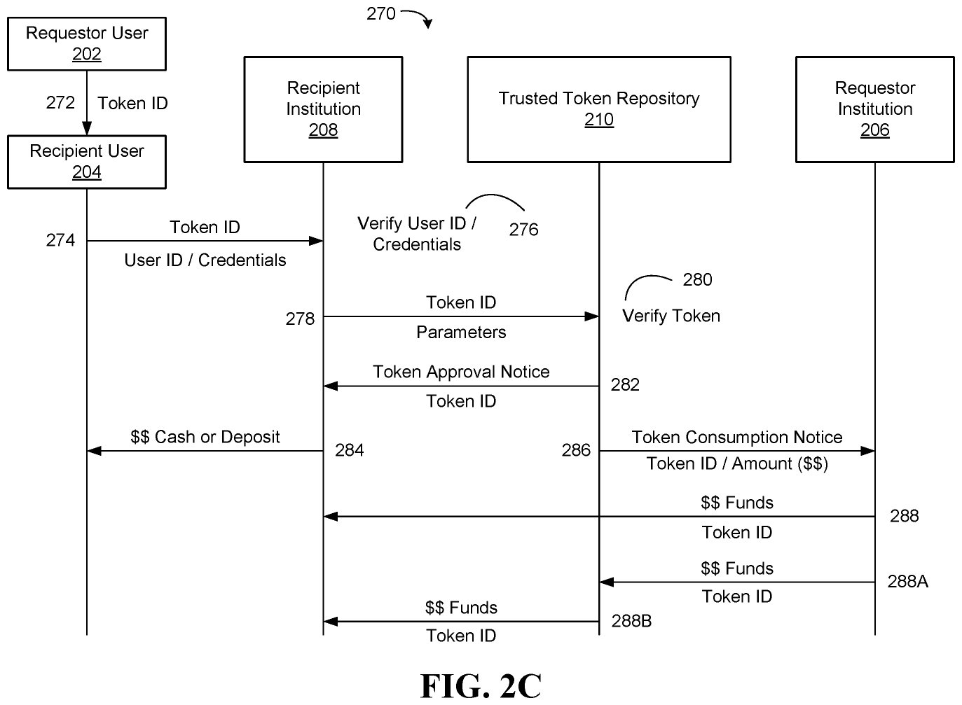

FIG. 2A is a diagram illustrating a process flow 200 for generating a trusted offline payment token according to one or more embodiments, with reference to components and features described herein including but not limited to the figures and associated description. Process flow 200 includes interactions between and among various entities, including Requestor User 202, Requestor Institution 206, and Trusted Token Repository 210. Requestor User 202 may be User_1 101 or User_2 102 and may interact with other entities via network 120 as described herein. Requestor Institution 206 may be Institution_A 104 or Institution_B 106 and may interact with other entities via network 120 as described herein. Trusted Token Repository 210 may be Trusted Token Repository 110 and may interact with other entities via network 120 as described herein.

At label 212, Requestor User 202 may initiate a request to obtain a trusted offline payment token for a withdrawal or transfer of cash, the token to be consumed at a later time. The request may be made to Requestor Institution 206, where Requestor User 202 may have an existing account. Requestor User 202 may initiate the request by contacting Requestor Institution 206 through various ways. For example, Requestor User 202 may access, using a client device via network 120, an online account with Requestor Institution 206, or may personally visit a facility operated by Requestor Institution 206.

As part of the request, Requestor User 202 may present credentials, such as a user identification (ID), as proof of the identity of Requestor User 202. For example, if accessing an online account with Requestor Institution 206, Requestor User 202 may be required to provide an online user ID and password at login, such that the identity of Requestor User 202 may be verified by Requestor Institution 206 for any activity carried out during the online session. As another example, if Requestor User 202 personally visits a facility operated by Requestor Institution 206, Requestor User 202 may present identification, e.g., in the form of a photo ID such as a government-issued driver's license or passport. Processes of requesting and generating a trusted offline payment token, carried out between Requestor Institution 206 and Trusted Token Repository 210 as described herein, may occur in like manner whether Requestor User 202 initiates a token request via online account access, in-person visit, etc.

Requestor User 202 may provide additional information as part of the request. For example, the amount of cash for withdrawal or transfer may be supplied. In some embodiments, Requestor Institution 206 may provide to Requestor User 202 an option to select a token value based upon one or more predetermined values (such as, e.g., $10, $20, $50, etc.). If the request is for a transfer, Requestor User 202 may also provide a name or other identifier for the recipient user (e.g., Recipient User 204 as shown in FIG. 2C) to receive the cash. In some embodiments, Requestor User 202 may also provide a name or other identifier for the recipient institution (e.g., Recipient Institution 208 as shown in FIGS. 2B-2C) through which Requestor User 202 or Recipient User 204 desires to obtain the cash. In some instances, Requestor User 202 may also provide a particular branch of the recipient institution where the cash withdrawal will take place. Requestor User 202 may also provide a valid time period or expiration date by which the withdrawal or transfer is to occur.

At label 214, Requestor Institution 206 may have received from Requestor User 202 the request for a withdrawal or transfer of cash to be carried out via a trusted offline payment token. The request may be accompanied by credentials, such as a user ID, to establish the identity of Requestor User 202. As discussed above, if accessing an online account with Requestor Institution 206, Requestor User 202 may be required to provide an online user ID and password at login, such that the identity of Requestor User 202 may be verified automatically by Requestor Institution 206 as part of the login process. If Requestor User 202 personally visits Requestor Institution 206, Requestor User 202 may present identification in the form of a photo ID such as a government-issued driver's license or passport that can be verified by an employee or agent of Requestor Institution 206 as identifying Requestor User 202. Other forms of identification for Requestor User 202 may be received by Requestor Institution 206 along with the request (such as, e.g., a bankcard issued by Requestor Institution 206). Along with the request, Requestor Institution 206 may receive information from Requestor User 202, such as the information described above with reference to label 212 (e.g., the amount of cash requested, the name of a recipient user, etc.).

At label 216, Requestor Institution 206 may confirm that the account of Requestor User 202 has sufficient funds to cover the requested token, and may place a hold on the account of Requestor User 202 for the requested amount. The hold may include removing funds in the amount requested from the account of Requestor User 202 and placing the funds in a separate or temporary account to await the anticipated consumption of the trusted offline payment token. The hold may be placed at any point in the process between receipt of the request from Requestor User 202 and dispensing of a token identifier to Requestor User 202.

At label 218, once the identify of Requestor User 202 has been verified, Requestor Institution 206 may send to Trusted Token Repository 210 a token request for a trusted offline payment token, along with parameters pertinent to the token. Parameters may include one or more of the following items: token amount (i.e., the amount of cash for withdrawal or transfer), an identifier for Requestor User 202, an identifier for Recipient User 204, an identifier for Requestor Institution 206, an identifier for Recipient Institution 208, a branch location for Recipient Institution 208, a key associated with Requestor Institution 206 or Recipient Institution 208, and/or a valid period or expiration date.

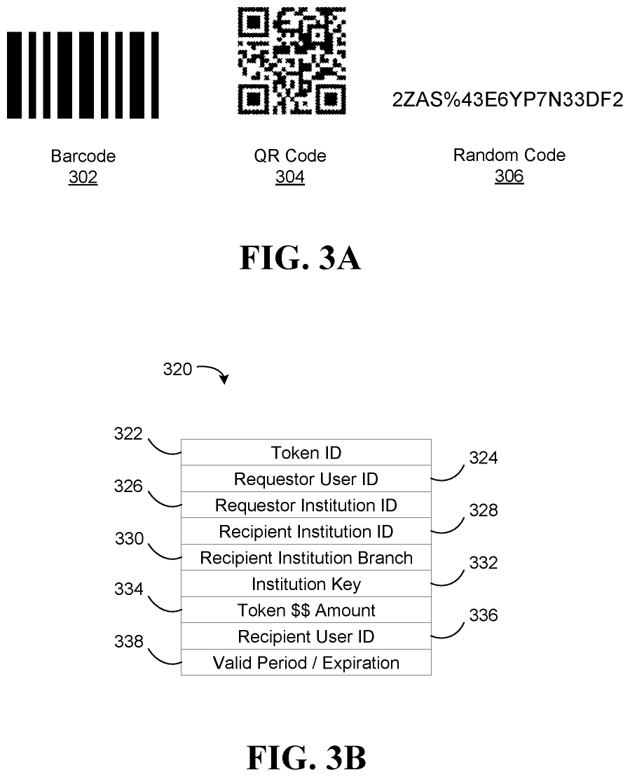

At label 220, Trusted Token Repository 210 may receive from Requestor Institution 206 the token request along with pertinent parameters. Based on the token request and accompanying parameters, Trusted Token Repository 210 may generate a trusted offline payment token, including a token identifier (ID) corresponding to the particular token. The trusted offline payment token (including token ID) may be of the form described below with reference to FIGS. 3A-3B. Trusted Token Repository 210 may store the generated trusted offline payment token in a secure token database maintained by (or on behalf of) Trusted Token Repository 210. The database may be configured to store a plurality of trusted offline payment tokens.

At label 222, Trusted Token Repository 210 may send to Requestor Institution 206 the token ID generated (label 220) in response to the token request (label 218). The token ID is sufficient to uniquely identify the token and to carry out any transfer and consumption of the token as described herein. By providing the token ID alone, and keeping the other token information stored confidentially in a secure database, Trusted Token Repository 210 can preserve the security and integrity of the trusted offline payment token.

At label 224, Requestor Institution 206 may have received from Trusted Token Repository 210 the token ID corresponding to the trusted offline payment token generated in response to the token request sent by Requestor Institution 206. Requestor Institution 206 may provide to Requestor User 202 the token ID. As described in more detail below with reference to FIG. 3A, the token ID may be provided in a form that can be electronically transmitted, displayed or reproduced—such as, e.g., a barcode, a QR code, or a random code. If Requestor User 202 is logged on to an online account with Requestor Institution 206, the token ID may be displayed to Requestor User 202 via a client device in a manner such that Requestor User 202 may print the token ID, or may store a copy of the token ID on the client device, to be recalled later at a time of withdrawal or transfer. Requestor Institution may send the token ID to Requestor User 202 via other means, such as e-mail or text message. If present in a facility of Requestor Institution 206, Requestor User 202 may be provided with a physical copy of the token ID, such as a printout or other physical media (e.g., memory stick).

FIG. 2B is a diagram illustrating a process flow 240 for managing trusted offline payment tokens according to one or more embodiments, with reference to components and features described herein including but not limited to the figures and associated description. Process flow 240 includes interactions between and among various entities, including Requestor User 202, Requestor Institution 206, Recipient Institution 208, and Trusted Token Repository 210. Recipient Institution 208 may be Institution_B 106 or Institution_A 104 and may interact with other entities via network 120 as described herein.

At label 242, Requestor User 202 may initiate a process to consume a trusted offline payment token by presenting a token ID corresponding to the trusted offline payment token, along with credentials, such as a user ID (which may be, e.g., photo ID), as proof of the identity of Requestor User 202. The token ID may be presented to Recipient Institution 208 so that Requestor User 202 may withdraw cash from Recipient Institution 208 in the amount set forth by the trusted offline payment token. In this scenario Requestor User 202 may be deemed the recipient user because Requestor User 202 is seeking to consume the trusted offline payment token by obtaining the cash amount. The trusted offline payment token may have been previously generated by Trusted Token Repository 210 and provided to Requestor User 202 by Requestor Institution 206 as described above with reference to FIG. 2A. Requestor User 202 may present the token ID and credentials in various ways, for example by personally visiting Recipient Institution 208 and presenting the token ID and credentials to an employee or agent of Recipient Institution 208, or via a kiosk, etc. Requestor User 202 may also use a client device to access an online account with Recipient Institution 208. If accessing an online account with Recipient Institution 208, Requestor User 202 may provide an online user ID and password at login, such that the identity of Requestor User 202 may be verified by Recipient Institution 208 for any activity carried out during the online session. The token ID may be presented in a form as described below with reference to FIGS. 3A-3B, and may be presented electronically, as a printout, via a client device display, etc.

At label 244, Recipient Institution 208 may have received from Requestor User 202 the token ID and request to consume the trusted offline payment token by a withdrawal of cash. The token ID may, for example, be scanned by Recipient Institution 208 into a form suitable for electronic transmission to Trusted Token Repository 210. The request may be accompanied by credentials to establish the identity of Requestor User 202. The credentials presented by Requestor User 202 may, e.g., be an online user ID and password (such that the identity of Requestor User 202 may be verified automatically by Recipient Institution 208 as part of the login process) or may be in the form of a photo ID such as a government-issued driver's license or passport, and may, e.g., be verified by an employee or agent of Recipient Institution 208 as identifying Requestor User 202. Other forms of identification for Requestor User 202 may be received for verification by Recipient Institution 208.

At label 246, once the identify of Requestor User 202 has been verified, Recipient Institution 208 may send to Trusted Token Repository 210 the token ID corresponding to the trusted offline payment token, along with parameters pertinent to the token. Parameters may include one or more of the following items: token amount (i.e., the amount of cash for withdrawal or transfer), an identifier for Requestor User 202, an identifier for the recipient user (which in this scenario would be Requestor User 202), an identifier for Requestor Institution 206, an identifier for Recipient Institution 208, a branch location for Recipient Institution 208, a key associated with Requestor Institution 206 or Recipient Institution 208, and/or a valid period or expiration date.

At label 248, Trusted Token Repository 210 may have received from Recipient Institution 208 the token ID along with the accompanying parameters. Trusted Token Repository 210 may use the token ID to locate and retrieve the corresponding the trusted offline payment token stored in the token database. Trusted Token Repository 210 may verify the trusted offline payment token by matching the accompanying parameters to the data stored as part of the token. For example, if the parameters include an identifier for Requestor User 202, Trusted Token Repository 210 may match the identifier for Requestor User 202 with the identifier for the requestor user in the stored token. If all required parameters match the corresponding data in the stored token, the token may be verified.

At label 250, if the trusted offline payment token is verified, Trusted Token Repository 210 may send to Recipient Institution 208 a token approval notice, authorizing Recipient Institution 208 to dispense cash to Requestor User 202 in the amount set forth in the token. The token approval notice may contain information such as token ID, token amount, identifier for Requestor User 202, etc. Upon sending a token approval notice, Trusted Token Repository may mark the token as consumed. In some embodiments, the token may be marked as consumed once the token amount is provided to Requestor User 202.

At label 252, Recipient Institution 208 may have received from Trusted Token Repository 210 the token approval notice, approving payment of the token amount to Requestor User 202. Recipient Institution 208 may make the payment in cash, or cash equivalent (e.g., card containing cash value in the amount of the token), or Recipient Institution 208 may deposit the cash amount in an account established in the name of Requestor User 202.

At label 254, Trusted Token Repository 210 may send to Requestor Institution 206 a token consumption notice, which advises Requestor Institution 206 that the trusted offline payment token has been consumed, i.e., that Trusted Token Repository 210 has verified the token and has authorized Recipient Institution 208 to pay the token amount to Requestor User 202. Trusted Token Repository 210 may send the token consumption notice prior to, contemporaneously with, or after sending the token approval notice as described with reference to label 250. The token consumption notice may contain information such as token ID, token amount, identifier for Requestor User 202, etc.

Trusted Token Repository 210 may also initiate a payment settlement process to transfer funds equal to the token amount for the consumed token from Requestor Institution 206 to Recipient Institution 208. The token consumption notice may contain a directive to Requestor Institution 206 to initiate the funds transfer.

At label 256, as a payment settlement process Requestor Institution 206 may initiate payment to Recipient Institution 208 of funds equal to the token amount for the consumed trusted offline payment token. Requestor Institution 206 may include the token ID along with the payment, to identify the token for which the payment corresponds. In some embodiments, as a payment settlement process, at label 256A, Requestor Institution 206 may initiate payment to Trusted Token Repository 210 of funds equal to the token amount for the consumed trusted offline payment token and, at label 256B, Trusted Token Repository 210 may in turn initiate payment of the same amount to Recipient Institution 208. Payment settlement may occur in the form of an electronic funds transfer, or may be handled in a manner similar to debit card transaction flow, and/or in any manner in which debit or credit amounts between financial institutions may be settled.

FIG. 2C is a diagram illustrating a process flow 270 for managing trusted offline payment tokens according to one or more embodiments, with reference to components and features described herein including but not limited to the figures and associated description. Process flow 270 includes interactions between and among various entities, including Requestor User 202, Recipient User 204, Requestor Institution 206, Recipient Institution 208, and Trusted Token Repository 110. Recipient User 204 may be User_2 102 or User_1 101 and may interact with other entities via network 120 as described herein.

At label 272, Requestor User 202 may transfer a token ID to Recipient User 204. The trusted offline payment token may have been previously generated by Trusted Token Repository 210 and provided to Requestor User 202 by Requestor Institution 206 as described above with reference to FIG. 2A. The token ID may be provided in a form as described below with reference to FIGS. 3A-3B, and may be provided, e.g., electronically, as a printout, via a client device display, etc.

At label 274, Recipient User 204 may initiate a process to consume the trusted offline payment token corresponding to the token ID received from Requestor User 202, by presenting the token ID, along with credentials, such as a user ID (which may be, e.g., photo ID), as proof of the identity of Recipient User 204. The token ID may be presented to Recipient Institution 208 so that Recipient User 204 may withdraw cash from Recipient Institution 208 in the amount set forth by the trusted offline payment token. In this scenario Recipient User 204 is the recipient user because Recipient User 204 is seeking to consume the trusted offline payment token by obtaining the cash amount. Recipient User 204 may present the token ID and credentials in various ways, for example by personally visiting Recipient Institution 208 and presenting the token ID and credentials to an employee or agent of Recipient Institution 208, or via a kiosk, etc. Recipient User 204 may also use a client device to access an online account with Recipient Institution 208. If accessing an online account with Recipient Institution 208, Recipient User 204 may provide an online user ID and password at login, such that the identity of Recipient User 204 may be verified by Recipient Institution 208 for any activity carried out during the online session. The token ID may be presented in a form as described below with reference to FIGS. 3A-3B, and may be presented electronically, as a printout, via a client device display, etc.

At label 276, Recipient Institution 208 may have received from Recipient User 204 the token ID and request to consume the trusted offline payment token by a withdrawal of cash. The token ID may, for example, be received electronically from Recipient User 204 or be scanned by Recipient Institution 208 into a form suitable for electronic transmission to Trusted Token Repository 210. The request may be accompanied by credentials to establish the identity of Recipient User 204. The credentials presented by Recipient User 204 may, e.g., be an online user ID and password (such that the identity of Recipient User 204 may be verified automatically by Recipient Institution 208 as part of the login process) or may be in the form of a photo ID such as a government-issued driver's license or passport, and may, e.g., be verified by an employee or agent of Recipient Institution 208 as identifying Recipient User 204. Other forms of identification for Recipient User 204 may be received for verification by Recipient Institution 208.

At label 278, once the identify of Recipient User 204 has been verified, Recipient Institution 208 may send to Trusted Token Repository 210 the token ID corresponding to the trusted offline payment token, along with parameters pertinent to the token. Parameters may include one or more of the following items: token amount (i.e., the amount of cash for withdrawal or transfer), an identifier for Requestor User 202, an identifier for Recipient User 204, an identifier for Requestor Institution 206, an identifier for Recipient Institution 208, a branch location for Recipient Institution 208, a key associated with Requestor Institution 206 or Recipient Institution 208, and/or a valid period or expiration date.

At label 280, Trusted Token Repository 210 may have received from Recipient Institution 208 the token ID along with the accompanying parameters. Trusted Token Repository 210 may use the token ID to locate and retrieve the corresponding the trusted offline payment token stored in the token database. Trusted Token Repository 210 may verify the trusted offline payment token by matching the accompanying parameters to the data stored as part of the token. For example, if the parameters include an identifier for Recipient User 204, Trusted Token Repository 210 may match the identifier for Recipient User 204 with the identifier for the recipient user in the stored token. If all required parameters match the corresponding data in the stored token, the token may be verified.

At label 282, if the trusted offline payment token is verified, Trusted Token Repository 210 may send to Recipient Institution 208 a token approval notice, authorizing Recipient Institution 208 to dispense cash to Recipient User 204 in the amount set forth in the token. The token approval notice may contain information such as token ID, token amount, identifier for Recipient User 204, etc. Upon sending a token approval notice, Trusted Token Repository may mark the token as consumed. In some embodiments, the token may be marked as consumed once the token amount is provided to Recipient User 204.

At label 284, Recipient Institution 208 may have received from Trusted Token Repository 210 the token approval notice, approving payment of the token amount to Recipient User 204. Recipient Institution 208 may make the payment in cash, or cash equivalent (e.g., card containing cash value in the amount of the token), or Recipient Institution 208 may deposit the cash amount in an account established in the name of Recipient User 204.

At label 286, Trusted Token Repository 210 may send to Requestor Institution 206 a token consumption notice, which advises Requestor Institution 206 that the trusted offline payment token has been consumed, i.e., that Trusted Token Repository 210 has verified the token and has authorized Recipient Institution 208 to pay the token amount to Recipient User 204. Trusted Token Repository 210 may send the token consumption notice prior to, contemporaneously with, or after sending the token approval notice as described with reference to label 282. The token consumption notice may contain information such as token ID, token amount, identifier for Recipient User 204, etc.

Trusted Token Repository 210 may also initiate a payment settlement process to transfer funds equal to the token amount for the consumed token from Requestor Institution 206 to Recipient Institution 208. The token consumption notice may contain a directive to Requestor Institution 206 to initiate the funds transfer.

At label 288, as a payment settlement process Requestor Institution 206 may initiate payment to Recipient Institution 208 of funds equal to the token amount for the consumed trusted offline payment token. Requestor Institution 206 may include the token ID along with the payment, to identify the token for which the payment corresponds. In some embodiments, as a payment settlement process, at label 288A Requestor Institution 206 may initiate payment to Trusted Token Repository 210 of funds equal to the token amount for the consumed trusted offline payment token and, at label 288B, Trusted Token Repository 210 may in turn initiate payment of the same amount to Recipient Institution 208. Payment settlement may occur in the form of an electronic funds transfer, or may be handled in a manner similar to debit card transaction flow, and/or in any manner in which debit or credit amounts between financial institutions may be settled.

In some circumstances, the token may not be verified by Trusted Token Repository 210. For example, if less than all parameters match, or if there is a missing parameter (i.e., the stored token includes a data element that is required to be matched but the data element is not provided in the parameters received from Recipient Institution 208), or if the date is not within a specified valid period for the token, Trusted Token Repository 210 may reject the token instead of verifying the token. In some embodiments, if the token is rejected Trusted Token Repository 210 may send an error message or error code to Recipient Institution 208.

If the token is not consumed within the time period set forth in the token—i.e. the token has expired, the token will not be verified by Trusted Token Repository 210 if presented after expiration. Trusted Token Repository 210 cancel the expired token and may notify Requestor Institution 206 that the token has expired without being consumed. Requestor Institution 206 may, upon notification that the token has expired, release the hold on the account of Requestor User 202 and return any funds removed from the account when the token was requested.

FIG. 3A illustrates example forms in which an identifier for a trusted offline payment token (token ID) may be presented according to one or more embodiments, with reference to components and features described herein including but not limited to the figures and associated description. The token ID may be provided in a form that can be electronically transmitted, displayed or reproduced—such as, e.g., barcode 302, QR code 304, or random code 306. The token ID may be created by assigning a unique numeric or alphanumeric code to a token (e.g., upon generation of the token), and encoding the unique numeric or alphanumeric code via an appropriate encoding scheme. For example, a barcode encoder may be used to generate barcode 302, a QR code encoder may be used to generate QR code 304, and a random number encoder may be used to generate random code 306. In some embodiments, the unique numeric or alphanumeric code may itself be used as a token ID without applying any further encoding.

FIG. 3B illustrates an example data structure for trusted offline payment token 320 according to one or more embodiments, with reference to components and features described herein including but not limited to the figures and associated description. Trusted offline payment token 320 may be stored in a secure token database maintained by (or on behalf of) Trusted Token Repository 210. Token 320 may include one or more data elements such as Token ID 322, Requestor User ID 324, Requestor Institution ID 326, Recipient Institution ID 328, Recipient Institution Branch 330, Institution Key 332, Token $$ Amount 334, Recipient Name 336, and Valid Period/Expiration 338. Token ID 322 may include the unique numeric or alphanumeric code to assigned to token and/or may include the encoded form, as described above with reference to FIG. 3A. Requestor User ID 324 may include a unique identifier for the requestor user (such as Requestor User 202). Requestor Institution ID 326 may include a unique identifier for the requestor institution (such as Requestor Institution 206). Recipient Institution ID 328 may include a unique identifier for the recipient institution (such as Recipient Institution 208). Recipient Institution Branch 330 may be a unique identifier for a particular branch office or location for the recipient institution. Institution Key 332 may include a key unique for a particular requestor institution or a particular recipient institution. Token $$ Amount 334 may include the amount of cash to be withdrawn or transferred via the token. Recipient Name 336 may include a full name for the recipient user (such as Recipient User 204). Valid Period/Expiration 338 may include a range of dates over which the token may be consumed (which may be a period of time in the future), and/or an expiration date by which the token must be consumed. If an expiration date is provided, the valid period would range from the date the token is issued until the expiration date. In some embodiments, other data elements may be stored as part of trusted offline payment token 320. For example, token 320 may include a token status indicator (not shown), which may include, e.g., a status such as issued, consumed, etc.

Institution Key 332 may be used as part of a token verification or consumption process. For example, if an institution key is included in the parameters provided by Requestor Institution 206 or Recipient Institution 208, Trusted Token Repository 210 may use the key as an additional way to verify the identify of Requestor Institution 206 or Recipient Institution 208. As another example, Trusted Token Repository 210 may send a key for Recipient Institution 208 along with the token ID, and Recipient Institution 208 may use the key to verify that the token is intended to be consumed by Recipient Institution 208; the key may be specific to a particular branch of Recipient Institution 208. As another example, Trusted Token Repository 210 may encrypt the token ID using a key for Recipient Institution 208, such that only Recipient Institution 208 would be able to unlock and access the token ID for consumption.

Trusted Token Repository 210, Requestor Institution 206 and/or Recipient Institution 208 may establish rules governing generation or consumption of trusted offline payment tokens. For example, rules may establish which parameters need to be provided by Requestor Institution 206 at the time a token is to be generated (such as an identifier for Recipient Institution 208 or Recipient User 204). Rules may establish what credentials may be required to permit identity of Requestor User 202 or Recipient User 204 to be verified. Rules may also establish how a lost token ID is handled; for example, if a token ID is lost, Requestor User 202 may be able to obtain another copy of the token ID from by Requestor Institution 206, or the token may be cancelled and re-issued via the token generation process described above with reference to FIG. 2A. Some rules may be default rules that apply in the absence of data or parameters provided by Requestor Institution 206 (such as, e.g., valid period/expiration).

Some or all rules (including those described above) may be based, e.g., on the amount of the token. For example, if the amount of the token exceeds a threshold value, the rules may require an additional form of identification to be presented at the time the token is generated or consumed. As another example, if the amount of the token is lower than a threshold value, the rules may allow consumption upon presentation of a user ID without requiring more (such as a photo ID); in such case, if the token is lost the token may nevertheless be consumed if a valid user ID is presented.

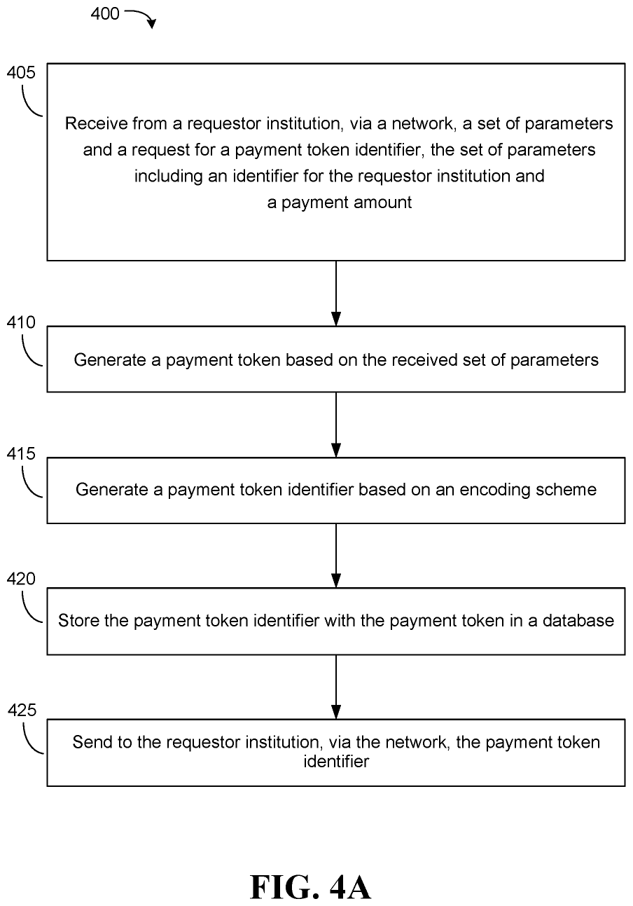

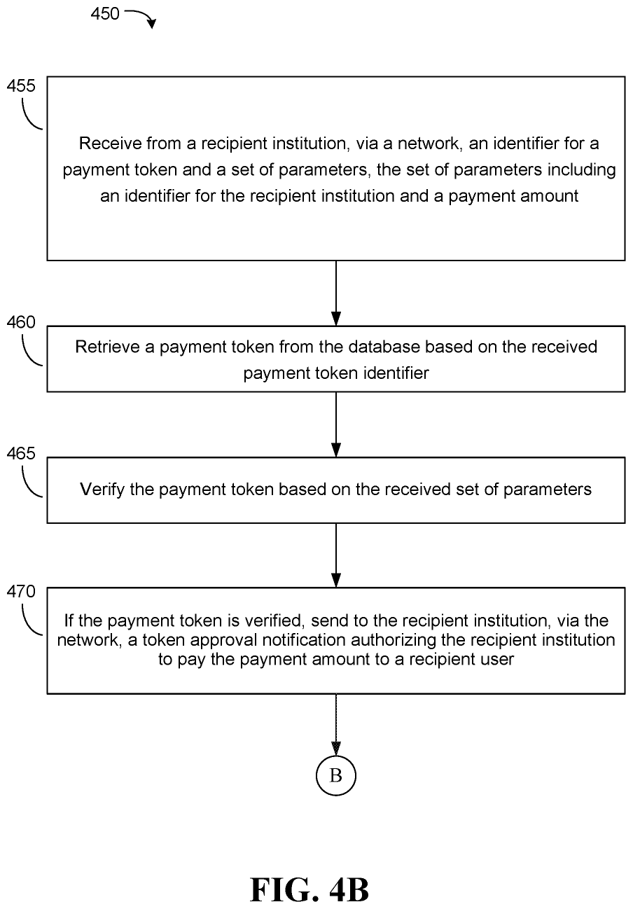

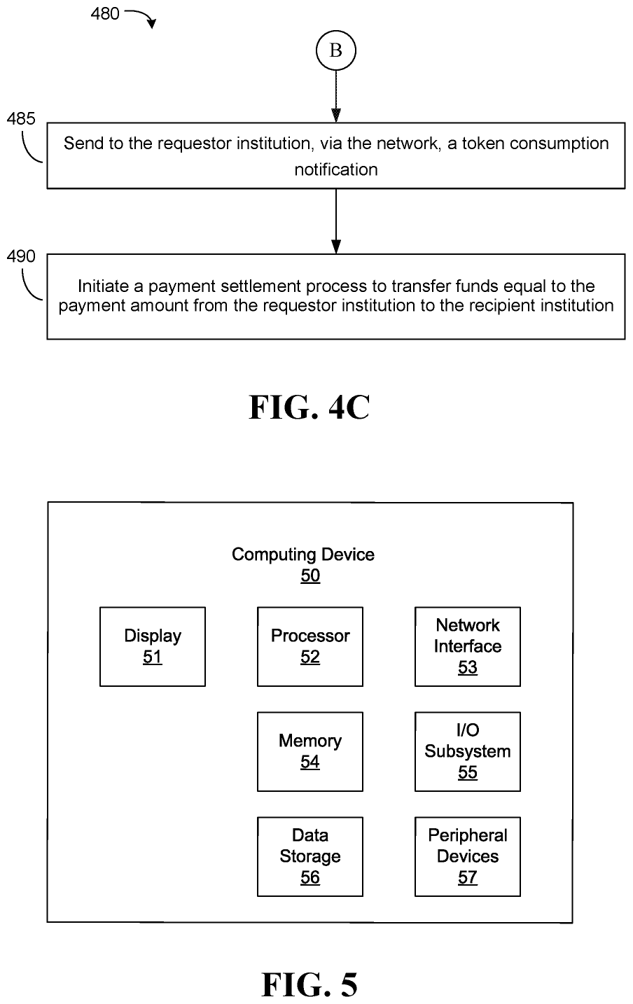

FIG. 4A provides a flowchart illustrating a method 400 for generating trusted offline payment tokens according to one or more embodiments, with reference to components and features described herein including but not limited to the figures and associated description. Method 400 may be carried out by components of system 100 including, e.g., Trusted Token Repository 110. In some embodiments, method 400 may be implemented in at least one non-transitory computer readable storage medium comprising a set of instructions which, when executed by a computing device (such as, e.g., the computing device described herein with reference to FIG. 5), cause the computing device to execute a series of steps. In some embodiments, method 400 may be executed by hardware elements (e.g., circuitry, fixed-function logic hardware, configurable logic, etc.). In some embodiments, method 400 may be implemented in combinations of hardware and software elements.

Processing block 405 may include receiving from a requestor institution, via a network, a set of parameters and a request for a payment token identifier, the set of parameters including an identifier for the requestor institution and a payment amount. The payment amount (i.e., token amount) is the amount of cash for withdrawal or transfer. In some embodiments, the set of parameters may also include one or more of an identifier for a requestor user, an identifier for a recipient user, an identifier for a recipient institution, a branch location for the recipient institution, a key associated with the requestor institution or the recipient institution, or a valid period or expiration date.

Processing block 410 may include generating a payment token based on the received set of parameters.

Processing block 415 may include generating a payment token identifier based on an encoding scheme. In some embodiments, the encoding scheme may include a barcode. In some embodiments, the encoding scheme may include a QR code. In some embodiments, the encoding scheme may include a random code.

Processing block 420 may include storing the payment token identifier with the payment token in a token database. The token database may be a secure database, and may be configured to store a plurality of trusted offline payment tokens.

Processing block 425 may include sending to the requestor institution, via the network, the payment token identifier. The payment token identifier may be provided to a requestor user and may subsequently be consumed by presenting to a recipient institution.

FIG. 4B provides a flowcharts illustrating a method 450 for consuming trusted offline payment tokens according to one or more embodiments, with reference to components and features described herein including but not limited to the figures and associated description. Method 450 may be carried out by components of system 100 including, e.g., Trusted Token Repository 110. In some embodiments, method 450 may be implemented in at least one non-transitory computer readable storage medium comprising a set of instructions which, when executed by a computing device (such as, e.g., the computing device described herein with reference to FIG. 5), cause the computing device to execute a series of steps. In some embodiments, method 450 may be executed by hardware elements (e.g., circuitry, fixed-function logic hardware, configurable logic, etc.). In some embodiments, method 450 may be implemented in combinations of hardware and software elements.

Processing block 455 may include receiving from a recipient institution, via a network, an identifier for a payment token and a set of parameters, the set of parameters including an identifier for the recipient institution and a payment amount. The payment amount (i.e., token amount) is the amount of cash for withdrawal or transfer. In some embodiments, the set of parameters may also include one or more of an identifier for a requestor user, an identifier for a recipient user, an identifier for a requestor institution, a branch location for the recipient institution, a key associated with the requestor institution or the recipient institution, or a valid period or expiration date.

Processing block 460 may include retrieving a payment token from the database based on the received payment token identifier.

Processing block 465 may include verifying the payment token based on the received set of parameters. The payment token may be verified by matching the received parameters to the data stored as part of the payment token. If all required parameters match the corresponding data in the stored token, the token may be verified.

Processing block 470 may include, if the payment token is verified, sending to the recipient institution, via the network, a token approval notification authorizing the recipient institution to pay the payment amount to a recipient user.

FIG. 4C provides a flowchart illustrating a method 480 for funds settlement for consumed trusted offline payment tokens according to one or more embodiments, with reference to components and features described herein including but not limited to the figures and associated description. Method 480 may be performed in conjunction with method 450, described above with reference to FIG. 4B. Method 480 may be carried out by components of system 100 including, e.g., Trusted Token Repository 110. In some embodiments, method 480 may be implemented in at least one non-transitory computer readable storage medium comprising a set of instructions which, when executed by a computing device (such as, e.g., the computing device described herein with reference to FIG. 5), cause the computing device to execute a series of steps. In some embodiments, method 480 may be executed by hardware elements (e.g., circuitry, fixed-function logic hardware, configurable logic, etc.). In some embodiments, method 480 may be implemented in combinations of hardware and software elements.

Processing block 485 may include sending to the requestor institution, via the network, a token consumption notification. The token consumption notification may indicate that the payment token has been consumed, i.e., that the payment token has been verified the token and that the recipient institution has been authorized to pay the payment amount to the requestor user or to the recipient user. The token consumption notification may be sent prior to, contemporaneously with, or after sending the token approval notice and authorization to the recipient institution. The token consumption notification may contain information such as token ID, payment amount, and one or more party identifiers.

Processing block 490 may include initiating a payment settlement process to transfer funds equal to the payment amount from the requestor institution to the recipient institution. The payment settlement process may be carried out as described above with reference to FIGS. 2B (labels 256, 256A and 256B) and 2C (labels 288, 288A and 288B).

FIG. 5 is a block diagram of a computing device 50 according to one or more embodiments, with reference to components and features described herein including but not limited to the figures and associated description. Computing device 50 may be used in implementing any of the devices or methods described herein with reference to FIGS. 1-4C. Although FIG. 5 illustrates certain components, computing device 50 may include additional or multiple components connected in various ways. It is understood that not all embodiments may necessarily include every component shown in FIG. 5. Computing device 50 may include display 51, processor 52, network interface 53, memory 54, I/O subsystem 55, data storage 56, and one or more peripheral devices 57.

Display 51 may be any type of device for presenting visual information, such as a computer monitor, a flat panel display, or a mobile device screen, and may include a liquid crystal display (LCD), a light-emitting diode (LED) display, a plasma panel, or a cathode ray tube display, etc.

Processor 52 may include one or more processing devices such as a microprocessor, a fixed application-specific integrated circuit (ASIC) processor, a reduced instruction set computing (RISC) processor, a complex instruction set computing (CISC) processor, a field-programmable gate array (FPGA), etc., along with associated circuitry, logic, and/or interfaces. Processor 52 may include, or be connected to, memory (such as, e.g., memory 54) storing executable instructions and/or data, as may be necessary or appropriate, when executed, to control, operate or interface with any devices or features of system 100 and/or implement any of the devices or methods described herein with reference to FIGS. 1-4C. Processor 52 may communicate, send or receive messages, requests, notifications, data, etc. to/from other devices, such as servers or client devices. Processor 52 may be embodied as any type of processor capable of performing the functions described herein. For example, processor 52 may be embodied as a single or multi-core processor(s), digital signal processor, microcontroller, or other processor or processing/controlling circuit.

Network interface 53 may include suitable logic, circuitry, and/or interfaces that transmits and receives data over communication networks using one or more communication network protocols. Network interface 53 may operate under the control of processor 52, and may transmit/receive various requests and messages to/from one or more other computing devices (such as, e.g., a server, client device, etc.). Network interface 53 may include wired or wireless data communication capability; these capabilities may support data communication with a wired or wireless communication network, including the Internet, a wide area network (WAN), a local area network (LAN), a wireless personal area network, a wide body area network, a cellular network, a telephone network, any other wired or wireless network for transmitting and receiving a data signal, or any combination thereof (including, e.g., a WiFi network or corporate LAN). Network interface 53 may support communication via a short-range wireless communication field, such as Bluetooth, NFC, or RFID. Examples of network interface 53 may include, but are not limited to, an antenna, a radio frequency transceiver, a wireless transceiver, a Bluetooth transceiver, an ethernet port, a universal serial bus (USB) port, or any other device configured to transmit and receive data.

Memory 54 may include suitable logic, circuitry, and/or interfaces to store executable instructions and/or data, as may be necessary or appropriate when, executed, to control, operate or interface with any devices or features of system 100 and/or implement any of the devices or methods described herein with reference to FIGS. 1-4C. Memory 54 may be embodied as any type of volatile or non-volatile memory or data storage capable of performing the functions described herein, and may include a random-access memory (RAM), a read-only memory (ROM), write-once read-multiple memory (e.g., EEPROM), a removable storage drive, a hard disk drive (HDD), a flash memory, a solid-state memory, and the like, and including any combination thereof. In operation, memory 54 may store various data and software used during operation of computing 50 such as operating systems, applications, programs, libraries, and drivers. Memory may be is communicatively coupled to processor 804 directly or via I/O subsystem 55.

I/O subsystem 55 may include circuitry and/or components suitable to facilitate input/output operations with processor 52, memory 54, and other components of computing device 50.

Data storage 56 may include any type of device or devices configured for short-term or long-term storage of data such as, for example, memory devices and circuits, memory cards, hard disk drives, solid-state drives, non-volatile flash memory, or other data storage devices. Data storage 56 may include or be configured as a database, such as a relational or non-relational database, or a combination of more than one database. In some embodiments, a database or other data storage may be physically separate and/or remote from computing device 50, may be located in another computing device, a database server, on a cloud-based platform, or in any storage device that is in data communication with computing device 50.

Computing device 50 may include one or more peripheral devices 57. Peripheral devices 57 may include any number of additional input/output devices, interface devices, and/or other peripheral devices, such as, for example, a display, touch screen, graphics circuitry, keyboard, mouse, speaker system, microphone, or network interface.

In some embodiments, one or more of the illustrative components of computing device 50 may be incorporated in, or otherwise form a portion of, another component. For example, memory 54, or portions thereof, may be incorporated in processor 52. In some embodiments, computing device 50 may be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device.

Techniques consistent with the present invention provide, among other features, systems and methods for establishing and managing trusted offline payment tokens. While various exemplary embodiments of the disclosed system and method have been described above it should be understood that they have been presented for purposes of example only, not limitations. It is not exhaustive and does not limit the invention to the precise form disclosed.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

What is claimed is:

1. A computing system for operating a trusted token repository, comprising:
a processor;
a database coupled to the processor, the database configured to store a plurality of trusted payment tokens, each trusted payment token comprising a payment token identifier, a payment amount, and one or more of a requestor institution identifier, a requestor user identifier, a recipient institution identifier, and a recipient user identifier;
a memory coupled to the processor, the memory storing instructions which, when executed by the processor, cause the computing system to:
receive from a recipient institution, via a network, a first payment token identifier and a first set of parameters, the first set of parameters including an identifier for a the recipient institution and a payment amount;
retrieve a first trusted payment token from the database based on the received first payment token identifier;
verify the first trusted payment token based on the received first set of parameters; and
if the first trusted payment token is verified, send to the recipient institution, via the network, a token approval notification authorizing the recipient institution to pay the payment amount to a recipient user.

2. The computing system of claim 1, wherein to verify the first trusted payment token based on the received first set of parameters, the instructions, when executed by the processor, further cause the computing system to match each parameter of the received first set of parameters to a corresponding value for the parameter in the retrieved first trusted payment token.

3. The computing system of claim 1, wherein the first trusted payment token contains parameters required according to a set of rules.

4. The computing system of claim 1, wherein the instructions, when executed by the processor, further cause the computing system to:
receive from a requestor institution, via the network, a second set of parameters and a request for the first payment token identifier, the second set of parameters including an identifier for the requestor institution, an identifier for the recipient institution, and the payment amount;
generate the first trusted payment token based on the received second set of parameters;
generate the first payment token identifier based on an encoding scheme;
store the first payment token identifier with the first trusted payment token in the database; and
send to the requestor institution, via the network, the first payment token identifier.

5. The computing system of claim 4, wherein the instructions, when executed by the processor, further cause the computing system to:
send to the requestor institution, via the network, a token consumption notification; and
initiate a payment settlement process to transfer funds equal to the payment amount from the requestor institution to the recipient institution.

6. The computing system of claim 4, wherein the received first set of parameters further includes an identifier for a recipient user, wherein the identity of the recipient user has been verified by the recipient institution, and wherein the received second set of parameters further includes an identifier for the recipient user.

7. The computing system of claim 4, wherein the first trusted payment token further comprises at least one of a key associated with the requestor institution or a key associated with the recipient institution.

8. At least one non-transitory computer readable storage medium comprising a set of instructions, which when executed by a computing device, cause the computing device to:
receive from a recipient institution, via a network, a first payment token identifier and a first set of parameters, the first set of parameters including an identifier for a the recipient institution and a payment amount;
retrieve a first trusted payment token from a database based on the received first payment token identifier;
verify the first trusted payment token based on the received first set of parameters; and
if the first trusted payment token is verified, send to the recipient institution, via the network, a token approval notification authorizing the recipient institution to pay the payment amount to a recipient user;
wherein the database is configured to store a plurality of trusted payment tokens, each trusted payment token comprising a payment token identifier, a payment amount, and one or more of a requestor institution identifier, a requestor user identifier, a recipient institution identifier, and a recipient user identifier.

9. The at least one non-transitory computer readable storage medium of claim 8, wherein to verify the first trusted payment token based on the received first set of parameters, the instructions, when executed, further cause the computing device to match each parameter of the received first set of parameters to a corresponding value for the parameter in the retrieved first trusted payment token.

10. The at least one non-transitory computer readable storage medium of claim 8, wherein the first trusted payment token contains parameters required according to a set of rules.

11. The at least one non-transitory computer readable storage medium of claim 8, wherein the instructions, when executed, further cause the computing device to:
receive from a requestor institution, via the network, a second set of parameters and a request for the first payment token identifier, the second set of parameters including an identifier for the requestor institution, an identifier for the recipient institution, and the payment amount;
generate the first trusted payment token based on the received second set of parameters;
generate the first payment token identifier based on an encoding scheme;
store the first payment token identifier with the first trusted payment token in the database; and
send to the requestor institution, via the network, the first payment token identifier.

12. The at least one non-transitory computer readable storage medium of claim 11, wherein the instructions, when executed, further cause the computing device to:
send to the requestor institution, via the network, a token consumption notification; and
initiate a payment settlement process to transfer funds equal to the payment amount from the requestor institution to the recipient institution.

13. The at least one non-transitory computer readable storage medium of claim 11, wherein the received first set of parameters further includes an identifier for a recipient user, wherein the identity of the recipient user has been verified by the recipient institution, and wherein the received second set of parameters further includes an identifier for the recipient user.

14. A method of operating a trusted token repository, comprising:
receiving from a recipient institution, via a network, a first payment token identifier and a first set of parameters, the first set of parameters including an identifier for a the recipient institution and a payment amount;
retrieving a first trusted payment token from a database based on the received first payment token identifier;
verifying the first trusted payment token based on the received first set of parameters; and
if the first trusted payment token is verified, sending to the recipient institution, via the network, a token approval notification authorizing the recipient institution to pay the payment amount to a recipient user;
wherein the database is configured to store a plurality of trusted payment tokens, each trusted payment token comprising a payment token identifier, a payment amount, and one or more of a requestor institution identifier, a requestor user identifier, a recipient institution identifier, and a recipient user identifier.

15. The method of claim 14, wherein verifying the first trusted payment token based on the received first set of parameters comprises matching each parameter of the received first set of parameters to a corresponding value for the parameter in the retrieved first trusted payment token.

16. The method of claim 14, wherein the first trusted payment token contains parameters required according to a set of rules.

17. The method of claim 14, further comprising:
receiving from a requestor institution, via the network, a second set of parameters and a request for the first payment token identifier, the second set of parameters including an identifier for the requestor institution, an identifier for the recipient institution, and the payment amount;
generating the first trusted payment token based on the received second set of parameters;
generating the first payment token identifier based on an encoding scheme;
storing the first payment token identifier with the first trusted payment token in the database; and
sending to the requestor institution, via the network, the first payment token identifier.

18. The method of claim 17, further comprising:
send to the requestor institution, via the network, a token consumption notification; and
initiate a payment settlement process to transfer funds equal to the payment amount from the requestor institution to the recipient institution.

19. The method of claim 17, wherein the received first set of parameters further includes an identifier for a recipient user, wherein the identity of the recipient user has been verified by the recipient institution, and wherein the received second set of parameters further includes an identifier for the recipient user.

20. The method of claim 17, wherein the first trusted payment token further comprises at least one of a key associated with the requestor institution or a key associated with the recipient institution.
